(19) United States
(12) Patent Application Publication
(10) Pub. No.: US 2006/0071791 A1
(43) Pub. Date: Apr. 6, 2006

(54) Enhanced RFID vehicle presence detection system

(75) Inventors: David W. Meyers, Brooklyn Park, MN (US); Douglas R. Carlson, Woodbury, MN (US); Jerome P. Drexler, Wyoming, MN (US); Robert C. Becker, Eden Prairie, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/955,345

(22) Filed: Sep. 29, 2004

(51) Int. Cl. G08B 13/14

(52) U.S. Cl. 340/572.1

(57) ABSTRACT

A security access system performing identification, verification and authorization is provided. In one embodiment, a security access system is disclosed. The security access system comprises, a radio frequency identification (RFID) activator loop integrated in an access road, a loop reactance sensing circuit, an RFID personal identification tag, an imaging device and a verification system. The loop reactance sensing circuit is adapted to measure the reactance of the RFID activator loop to determine the presence of a vehicle. The RFID personal identification tag is adapted to transmit identification data regarding the person it is associated with in response to the RFID activator loop. The imaging device is adapted to record an image of the person. The verification system is adapted to process the identification data of the RFID identification tag and produce an image of the person from a database associated with the identification data.

### TECHNICAL FIELD

The present invention relates generally to security systems and, in particular, to identification, verification and authorization in security access systems.

### BACKGROUND

In recent years, security systems have become an integral part of guarding and protecting critical infrastructures and locations. Typically, security access is achieved using manual (e.g., visual verification by a guard, physical punching of pass-code, etc.) or electronic systems (e.g., Radio Frequency Identification (RFID), key-card entry, etc.). Manual systems are susceptible to human error that may lead to a breach in security. In addition, lower speeds and higher costs are often associated with using manual security. Hence, to avoid these disadvantages, electronic security systems are used more often.

RFID systems are generally reliable and efficient. However, when RFID systems are used by themselves, they are not adequately effective in securing access. Unauthorized personnel in possession of a valid RFID tag or a vehicle having a valid RFID tag may be allowed access. Another system used in security systems is facial recognition verification. Facial recognition is achieved by recording a picture of the person and executing biometric verification programs to determine the identity of the individual. Biometric verification involves positive interaction (such as stopping the vehicle for a picture to be taken) that slows the authorization process. In situations where a number of vehicles are waiting to get past a security guard gate, coordinating the RFID tag signals with the biometric verification to complete access authorization can be difficult. Also mechanical detection of synchronization processes is highly unreliable and it is generally desired to eliminate the need for mechanical vehicle detection actuators.

For the reasons stated above and for other reasons stated below which will become apparent to those skilled in the art upon reading and understanding the present specification, there is a need in the art for rapid, reliable and convenient verification of biometric data against credentials presented for authorized access control.

### SUMMARY

The above-mentioned problems and other problems are resolved by the present invention and will be understood by reading and studying the following specification.

In one embodiment, a security access system is disclosed. The security access system comprises, a radio frequency identification (RFID) activator loop integrated in an access road, a loop reactance sensing circuit, an RFID personal identification tag, an imaging device and a verification system. The loop reactance sensing circuit is adapted to measure the reactance of the RFID activator loop to determine the presence of a vehicle. The RFID personal identification tag is adapted to transmit identification data regarding the person it is associated with in response to the RFID activator loop. The imaging device is adapted to record an image of the person. The verification system is adapted to process the identification data of the RFID identification tag and produce an image of the person from a database associated with the identification data.

In another embodiment, a security access system is disclosed, the security access system includes a loop reactance sensing circuit, an imaging device, an identification (ID) tag, a verification system and a synchronization module. The loop reactance sensing circuit is adapted to detect the presence of a vehicle. The imaging device is adapted to capture facial images of persons in the vehicle upon detection of the presence of the vehicle. The ID tag is assigned to each person having access rights to a restricted area. Each ID tag is adapted to be carried on the person it is associated with. Moreover, each ID tag further is further adapted to electronically store ID information associated with the person who is carrying the ID tag. The verification system is adapted to read ID information stored on ID tags upon detection of the vehicle and compare stored facial images associated with each ID tag with the captured facial images from the imaging device. The verification system is further adapted to allow access to the restricted area when at least one match of the captured facial image and the stored facial image occur. In addition, the synchronization module is adapted synchronize the verification system upon the loop reactance sensing circuit determining the present of a vehicle.

In still another embodiment, a security access system is disclosed. The security access system includes a road loop, an RFID personal identification tag and a verification system. The road loop is integrated in an access road. The RFID personal identification tag is associated with a person in the vehicle. The RFID personal identification tag is adapted to transmit personal data in response to the road loop. The verification system includes a loop reactance sensing circuit, a receiver, an imaging device, a database and a computer. The loop reactance sensing circuit is coupled to sense changes in reactance in the road loop to track the motion of the vehicle over the road loop. The receiver is adapted to receive the personal data transmitted by the RFID personal identification tag. The imaging device is adapted to record an image of the person in the vehicle. The database is used to store images of persons authorized to access a restricted and the computer is used to compare store images associated with the transmitted personal data and an image taken by the imaging device to provide verification.

In yet another embodiment, a radio frequency identification (RFID) vehicle presence detection system is disclosed. The detection system comprises an RFID activator loop and a loop reactance sensing circuit. The RFID activator loop is adapted to be integrated in an access road. The loop reactance sensing circuit is coupled to sense changes in the reactance of the RFID activator loop to determine the presence of a vehicle.

In another embodiment, a method for synchronizing image recognition with vehicular movement is disclosed. The method comprises measuring the reactance of an activator loop to determine the presence of a vehicle. Transmitting identification information in response to the activation of one or more RFID devices in response to the activation loop. Capturing one or more images associated with at least one of the RFID devices and verifying captured images with images stored in a database

In yet another embodiment, a method of allowing select access to a secure location is disclosed. The method comprising, tracking the motion of a vehicle nearing the secure location, imaging a body associated with the vehicle, time stamping each image to create a stored record, processing identification information from an RFID tag associated with the body, comparing an image of the body with a stored image associated with the RFID tag and when the image of the body and the stored image match, allowing access to the secure location.

In further yet another embodiment, a machine readable medium having instructions stored thereon for allowing select access to a secure location is disclosed. The method comprising, detecting change in reactance in a loop field, initiating time tracking process, imaging the body, comparing an image of the body with a stored image associated with information received from an RFID tag activated by the loop field and indicating a match when the image of the body and the stored image match.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is an illustration of one embodiment of a security system for Vehicle/Driver Recognition of the present invention;

FIG. 2 is a block diagram of one embodiment of a Vehicle Location Event Synchronization Algorithm for security systems of the present invention;

FIG. 3 is a flow chart of a method of operation of one embodiment of a security system for Vehicle/Driver Recognition of the present invention; and

FIG. 4 is an illustration of another embodiment of a security system enabled to provide Gate Vehicle/Driver Recognition of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

The present invention provides a security system that allows reliable and accurate vehicle and driver recognition for access security. With this invention, the driver's out-of-the-vehicle-presence along with human contact is not needed. In addition, the present invention significantly reduces the amount of time needed to perform vehicle and driver recognition. In one embodiment, a security system is provided that reliably and accurately performs RFID-based verification. The security system integrates hands-free RFID technology with hands-free facial recognition technology in order to provide an access control database with a one-to-one dynamic, positive biometric verification. Embodiments of the present invention use a road loop to activate RFID devices associated with a car and driver (i.e. identification tags). When the devices are activated they send an identification signal to a processor that initiates a video device to record an image of the vehicle and a driver. The images are then compared to stored images associated with the RFIDs. If there is a match, an access gate is opened. If there is not a match, the access gate remains closed. Embodiments of the invention also time stamp the video so a time record is established.

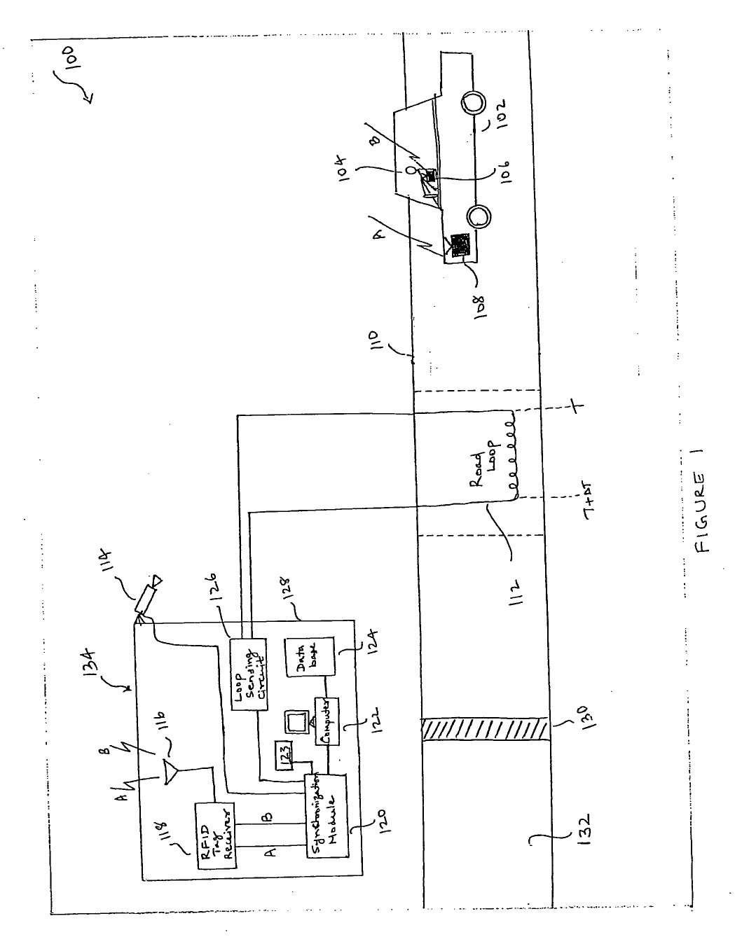

Referring to FIG. 1, an illustration of a security access system 100 for Vehicle/Driver Recognition of one embodiment of the present invention is illustrated. Security system 100 includes of a road loop 112, a vehicle identification tag 108, a personal identification tag 106, an RFID tag receiver 118, an imaging device 114 and a verification system 128. The personal identification tag 106 and vehicle identification tag 108 are RFID devices capable of transmitting signals to distinctly identify themselves from other similar RFID devices. In one embodiment, the tags 106 and 108 contain a small transponder that is in a sleep state until activated. Tags 106 and 108 are activated in this embodiment by the road loop 112. The road loop 112 (or RFID activator loop 112) also enables sensing of vehicles that enter the loop. The road loop 112 is integrated in the access road 110 (i.e. rests on or is embedded in the access road 110) in such a way that vehicles have to drive over it to access the secure zone 132. Access road 10 includes a gate 130 that restricts vehicle access to secure zone 132. Vehicle 102 includes a person 104, a personal identification tag 106 and a vehicle identification tag 108. When vehicle 102 enters activator loop 112, the reactance of the road loop 112 changes thereby indicating the presence of a vehicle. In one embodiment, road loop 112 is an activator loop that is an active device. The activator loop 112 activates or triggers a personal identification tag 106 and/or a vehicle identification tag 108 to transmit identification information that can be received at security guard station 134. In another embodiment, road loop 112 is a passive device. Gate 130 in this embodiment of the invention controls access of vehicles into a secure area 132.

The verification system 128 includes an imaging device 114, an antenna 116, an RFID tag receiver 118, a synchronization module 120, a computer 122, a database 124 and a loop reactance sensing circuit 126. In one embodiment the verification system 128 is housed in a security guard station 134 or the like. The verification system 128 determines whether the vehicle 102 should be allowed access to the secure area 132. Antenna 116 receives signals from personal identification tag 106 and vehicle identification tag 108 once they are activated. The signals received by antenna 116 are passed to the RFID tag receiver 118. In one embodiment, the RFID receiver 118 verifies the validity of the signals it receives. In another embodiment, RFID receiver 118 receives periodic updates on valid RFID tag signals from database 124. Still in another embodiment, a processor in the computer 122 provides verification function of valid RFID tags 108 and 104. In one embodiment the RFID tag receiver 118 is coupled to synchronization module 120. As illustrated in FIG. 1, the synchronization module 120 is coupled to the RFID receiver 118, the imaging device 114, the loop reactance sensing circuit 126 and computer 122. In one embodiment, imaging device 114 captures streaming video of vehicles and persons within the vehicle desiring access to secure zone 132. The person or vehicle can generally be referred to as the body. Loop reactance sensing circuit 126 senses the presence of a vehicle within road loop 112. Generated time stamps are forwarded to synchronization module 120.

Synchronization module 120 of this embodiment receives signals from RFID tag receiver 118, video device 114 and loop reactance sensing circuit 126. In one embodiment, computer 122 is coupled to database 124. In one embodiment, synchronization module 120 performs a synchronization function based on time stamps by correlating captured images to relative positions of vehicle 102 while passing over the road loop 112. Based on these time stamps from loop reactance sensing circuit 126, appropriate sections of a continuous video stream recorded at video device 114 are used for image recognition and verification of biometric data. These video stream sections are compared to reference images stored in database 124. In one embodiment, verification system 128 is adapted to read the identification data of the RFID identification tag and produce an image of the body from a database associated with the identification data.

Computer 122 runs a software program to execute a vehicle location event synchronization algorithm. Synchronization module 120 works in conjunction with the vehicle location event synchronization algorithm to determine and analyze appropriate portion of the video stream recorded by video camera 114. When vehicle 102 moves across road loop 112, time stamps are generated and used by synchronization algorithm and synchronization module to determine relevant portion of the video stream to be used for biometric verification. Moreover, in one embodiment, a storage device 123 is used to store a record of the vehicle and the person within the vehicle.

In one embodiment, one a personnel RFID tag 106 is used. This embodiment has the advantage of not limiting authorized personnel 104 to only a specific vehicle 102. In this embodiment, the personal RFID tag 106 transmits personnel data associated with the personnel RFID tag 106 in response to the RFID road loop 112. Meanwhile, the loop reactance sensing circuit 126 detects the presence of the vehicle 102 by monitoring for a change in reactance in the RFID road loop 112. The loop reactance sensing circuit 126 sends a signal to the synchronization module 120 when the presence of a vehicle 102 has been detected. The synchronization module 120 synchronizes the verification process. The verification process includes imaging the person 104 in the vehicle, processing the received personnel data through the antenna 134 and RFID 118 and comparing stored data in the data base 124 associated with received personnel data and the image of the person 104 in the vehicle with a processor in a computer 122.

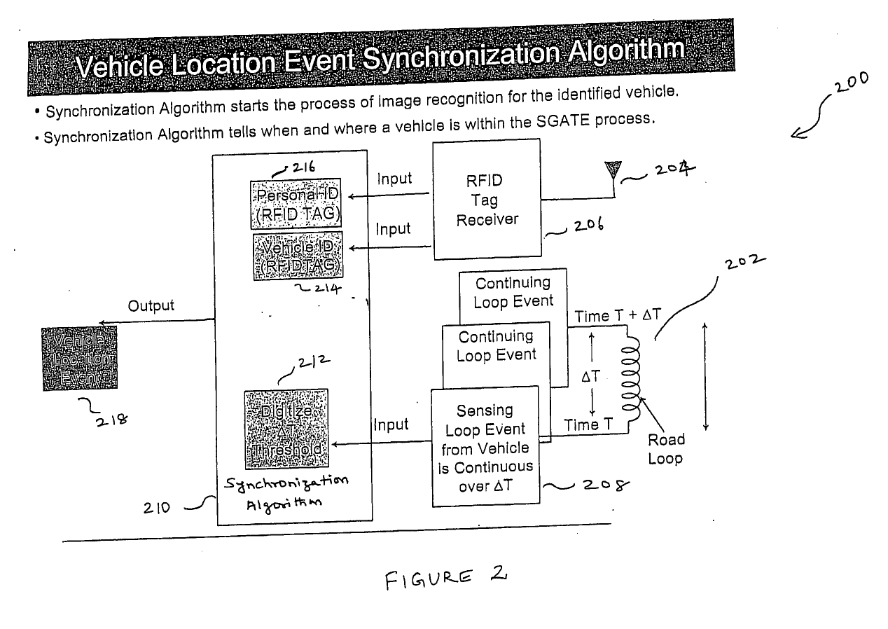

FIG. 2 is a block diagram of a vehicle location event synchronization system, indicated generally at 200. In one embodiment, synchronization system 200 includes an antenna 204, a road loop 202, an RFID tag receiver 206, a loop reactance sensing event module 208, a synchronization algorithm 210 and a vehicle location event 218. In one embodiment, the synchronization algorithm 210 includes a personal RFID tag module 216, a vehicle RFID tag module 214 and a digitize ΔT threshold module 212. The synchronization algorithm 210, ensures that the correct vehicle including RFID tag in the loop is uniquely matched to the image captured. The personal RFID tag module 216 and the Vehicle RFID tag module 214 are coupled to receive inputs from the RFID tag receiver 206 which in turn is coupled to antenna 204. In one embodiment of the present invention, digitize ΔT threshold module 212 receives inputs from the loop reactance sensing event module 208. Loop reactance sensing event module 208 is connected to road loop 202 and identifies the presence of any vehicle entering the field of the road loop 202 by determining the change in reactance produced due to the high metallic content in the vehicle. The reactance of the road loop 202 changes in a predictable and measurable manner in the presence of a vehicle. Upon determining the presence and position of the vehicle digitize ΔT threshold module 212 generates a time stamp that is used to identify the position of the vehicle as it proceeds across the road loop 202. A stored record of the vehicle as it crosses the road loop is preformed in embodiments of the present invention. Output of synchronization algorithm is forwarded to vehicle location event module 218 which indicates the where the vehicle is within the access verification process. The synchronization algorithm also starts the process of image recognition.

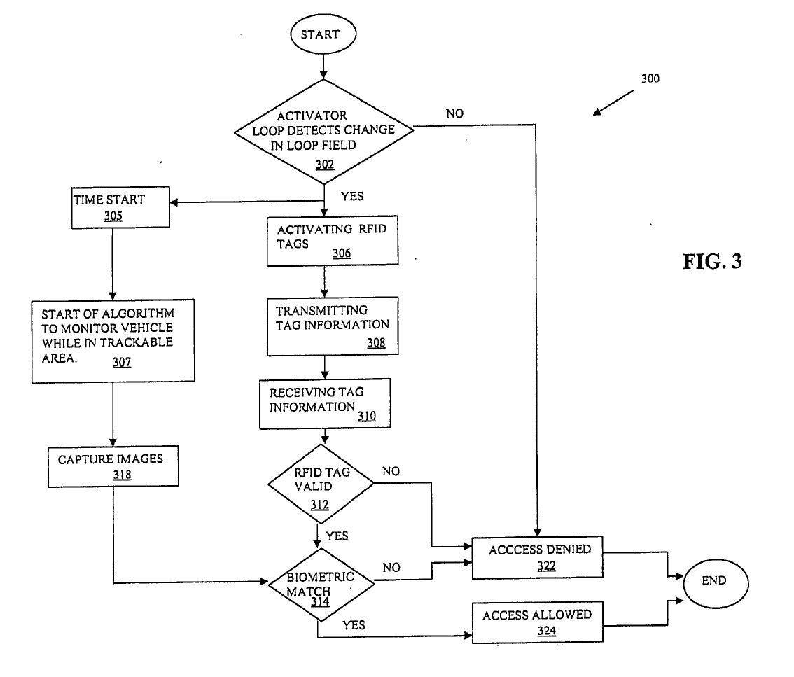

FIG. 3 is a flow chart of a method of operation of one embodiment of a security system for Vehicle/Driver Recognition of the present invention. The security system determines whether a vehicle should be allowed or denied access to a secure zone. The method starts by determining whether the vehicle has entered the field of an activator loop (302). If the vehicle has not entered the field of the activator loop, access is denied (324). When a vehicle enters the field of the activator loop, the activator loop electronically detects the presence of the vehicle (302). In one embodiment, this is done by detecting a change in reactance in the activator loop. Following the detection of the presence of the vehicle (302), the activator loop activates RFID tags on the vehicle and in possession of the person in the vehicle (306). Upon activation of the RFID tags, the vehicle and person RFID tags transmit RFID tag information (308). The transmitted RFID tag information is received by the verification system (310). The verification system then determines if the received RFID tag information is valid (312). If the RFID tag information is not valid (312), the vehicle is denied access (322).

Following the detection of the presence of the vehicle (302), a time record of the vehicle entering into the system is also started (305). Subsequently, algorithms to monitor vehicle while in tracking area are started (307). A video imaging device then begins capturing images of the vehicle and person driving the vehicle (318). In one embodiment, the imaging device is a digital video camera. A captured image (318) by the video imaging device is compared with stored image that is associated with the valid RFID tag information (314). In the embodiment, a stored facial image associated with received tag information (310) is compared with a facial image captured by the video imaging device (318). If there is a biometric match (314), access is allowed. If there is not a biometric match (314), access is denied (322). In other embodiments of the present invention, an image of the vehicle is compared to a stored image of the vehicle associated with the RFID vehicle tag in determining access to the secure location. In further other embodiments both biometric and vehicle image identification is used. Moreover, in other embodiments, other biometric images are compared such as hand, iris, etc.

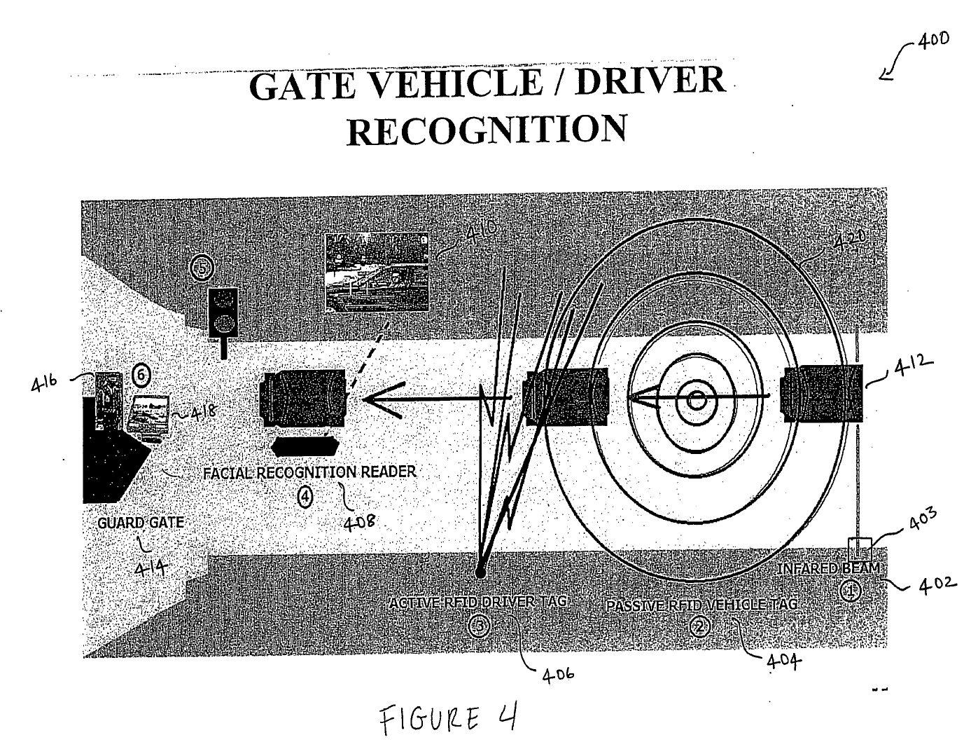

FIG. 4, is further another example of an embodiment of a security system 400 of the present invention. In this embodiment, the security system 400 includes an infrared beam 402, a road loop 420, a passive RFID vehicle tag identification 404, a active RFID driver tag identification 406, a facial recognition reader 408, a captured biometric image 410, a stored biometric image 418 and guard gate 414. In one embodiment, infrared beam 402 from an infrared detection circuit 403 is used to detect entry of a vehicle into security system 400. Road loop 420 performs the function of tracking the motion of the vehicle by measuring the change in reluctance of the coil used in the loop. In the passive RFID identification region 404, the vehicle continuously sends a signal from the RFID devices in the automobile. In one embodiment, the security system has an active RFID tag identification region 406 that communicates an activating signal to the RFID device which triggers the transmission of identification information at the RFID device. Facial recognition reader 408 captures biometric image 410 and compared with stored biometric image 418. Guard 416 checks for matches in captured biometric images 410 with stored biometric images 418 at guard gate 414. In other embodiments, image verification of the vehicle is preformed similarly to the biometric verification. Moreover, the present application is not limited to the verification of persons and vehicles since other items can be verified in a similar manner.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A security access system, the security access system comprising:
a radio frequency identification (RFID) activator loop integrated in access road;
a loop reactance sensing circuit adapted to measure the reactance of the RFID activator loop to determine the presence of a vehicle;
an RFID personal identification tag adapted to transmit identification data regarding the person it is associated with in response to the RFID activator loop;
an imaging device adapted to record an image of the person; and
a verification system adapted to process the identification data of the RFID personnel identification tag and produce an image of the person from a database associated with the identification data.

2. The security access system of claim 1, further comprising:
a synchronization module adapted synchronize the verification system upon the loop reactance sensing circuit determining the present of a vehicle.

3. The security access system of claim 1, further comprising:
a display adapted to display the image of the person from the database associated with the identification data to allow for visual conformation.

4. The security access system of claim 1 wherein the RFID personal identification tag is an active RFID tag.

5. The security access system of claim 1, further comprising:
a facial recognition reader adapted to compare facial data in the database associated with the RFID tag and a facial image recorded by the imaging device.

6. The security access system of claim 1, wherein the loop reactance sensing circuit is further adapted to track the position of the vehicle over the RFID activator loop.

7. The security access system of claim 6, wherein the loop reactance sensing circuit and the RFID activator are functions of the same loop.

8. The security access system of claim 6, further comprising:
a storage device adapted to store a record of the vehicle and person.

9. The security access system of claim 1, further comprising:
an RFID vehicle identification tag associated with the vehicle, the RFID vehicle identification tag adapted to transmit vehicle identification information in response to the RFID activator loop; and
the verification system further adapted to verify if the vehicle identification information is valid.

10. The security system of claim 9, wherein the RFID identification tag is a passive RFID vehicle tag.

11. A security access system comprising:
a loop reactance sensing circuit adapted to detect the presence of a vehicle;
an imaging device adapted to capture facial images of persons in the vehicle upon detection of the presence of the vehicle;
an identification (ID) tag for each person having access rights to a restricted area, each ID tag adapted to be carried on the person it is associated with, each ID tag further adapted to electronically store ID information associated with the person who is carrying the ID tag;
a verification system adapted to read ID information stored on ID tags upon detection of the vehicle and compare stored facial images associated with each ID tag with the captured facial images from the imaging device, the verification system further adapted to allow access to the restricted area when at least one match of the captured facial image and the stored facial image occur; and
a synchronization module adapted to synchronize the verification system upon the loop reactance sensing circuit determining the present of a vehicle.

12. The security access system of claim 11, wherein the loop reactance sensing circuit further comprises:
a road loop adapted to change reactance in response to the vehicle.

13. The security access system of claim 11, wherein the imaging device continuously records the images associated with vehicles entering into the field of the road loop.

14. The security access system of claim 11, wherein the imaging device is a video camera.

15. The security access system of claim 11, wherein the verification system is further adapted to time stamp the images captured by the imaging device.

16. The security access system of claim 11, wherein each ID tag is radio frequency identification device (RFID) adapted to transmit its stored ID information in response to the loop reactance sensing circuit.

17. The security access system of claim 16, wherein the frequency of each RFID is programmable.

18. The security access system of claim 16, wherein the verification system further comprises:
a receiver adapted to receive the transmitted ID information from each RFID.

19. The security access system of claim 18, wherein received ID information from the receiver is verified as being valid.

20. A security access system comprising:
a road loop integrated in an access road;
an RFID personal identification tag associated with a person in the vehicle, the RFID personal identification tag adapted to transmit personal data in response to the road loop; and
a verification system, the verification system including,
a loop reactance sensing circuit coupled to sense changes in reactance in the road loop to track the motion of the vehicle over the road loop,
a receiver adapted to receive the personal data transmitted by the RFID personal identification tag,
an imaging device adapted to record an image of the person in the vehicle,
a database to store images of persons authorized to access a restricted, and
a computer to compare store images associated with the transmitted personal data and an image taken by the imaging device to provide verification.

21. The security access system of claim 20, wherein the verification system further comprises:
a synchronization module adapted to synchronize the imaging of the person while the vehicle travels across the road loop.

22. The security access system of claim 21, wherein the synchronous module is adapted to start upon detection of a vehicle by the loop reactance sensing circuit.

23. The security access system of claim 21, further comprising:
an inferred detection circuit adapted to detect the presence of a vehicle, wherein the synchronous module is adapted to start up upon detection of the vehicle with the inferred detection circuit.

24. The security access system of claim 20, further comprising:
an RFID vehicle identification tag associated with the vehicle, the FRID vehicle identification tag adapted to transmit vehicle data in response to the road loop; and
wherein the verification system is further adapted to verify if the vehicle data is valid.

25. A radio frequency identification (RFID) vehicle presence detection system, the detection system comprising:
an RFID activator loop adapted to be integrated in an access road: and
a loop reactance sensing circuit coupled to sense changes in the reactance of the RFID activator loop to determine the presence of a vehicle.

26. The detection system of claim 25, further comprising:
an RFID personal tag associated with each person authorized to have access to a secure zone upon which the access road travels, each RFID personal tag containing ID information regarding the authorized person that is transmitted in response to the RFID activation loop;
an RFID receiver adapted to receive the transmitted ID information;
an imaging device adapted to take at least one image of persons in the vehicle seeking access to the secure zone;
a synchronization module adapted to synchronize the image taking with the recognition of the presence of the vehicle by the loop reactance sensing circuit;
a database adapted to store biometric information associated with each RFID tag; and
a processor adapted to compare the stored biometric information associated with the transmitted ID information to the at least one image captured by the image device to provide biometric verification.

27. The detection system of claim 26, wherein the synchronization module is further adapted to provide time stamping by correlating captured images to relative positions of the vehicle while passing over the road loop.

28. The detection system of claim 26, further comprising:
a vehicle location event module adapted to track the location of the vehicle from an output of the synchronization module.

29. The detection system of claim 26, further comprising:
an RFID vehicle tag associated with the vehicle having authorization to the secure zone, the RFID vehicle tag containing ID information regarding the authorized vehicle that is transmitted upon entering the RFID activation loop.

30. The detection system of claim 29, wherein the processor is adapted to verify the authorization to the secure zone of the vehicle based on the ID information received from the RFID vehicle tag.

31. A method for synchronizing image recognition with vehicular movement, the method comprising:
measuring the reactance of an activator loop to determine the presence of a vehicle;
transmitting identification information in response to the activation of one or more RFID devices in response to the activation loop;
capturing one or more images associated with at least one of the one of more RFID devices; and
verifying captured images with images stored in a database.

32. The method of claim 31, wherein one of the one or more devices is attached to the vehicle.

33. The method of claim 31, further comprising:
generating a time stamp associated with each captured image

34. The method of claim 31, wherein one of the one or more RFID devices are associated with a person.

35. The method of claim 34, wherein verifying captured images includes biometric verification.

36. A method of allowing select access to a secure location, the method comprising:
tracking the motion of a vehicle nearing the secure location;
imaging a body associated with the vehicle;
time stamping each image to create a stored record;
processing identification information from an RFID tag associated with the body;
comparing an image of the body with a stored image associated with the RFID tag; and
when the image of the body and the stored image match, allowing access to the secure location.

37. The method of claim 36, wherein tracking the motion of the vehicle further comprises:
measuring change in reactance in an RFID activator loop.

38. The method of claim 36, wherein detecting the body nearing the secure location further comprises:
using an infrared beam.

39. The method of claim 36, further comprising:
activating the RFID tag; and
in response to the activation, transmitting the identification information.

40. The method of claim 36, wherein comparing an image of the body with a stored image further comprises:
performing a biometric verification.

41. The method of claim 36, further comprising:
synchronizing the timing of events.

42. The method of claim 36, further comprising:
verifying the validity of the RFID tag.

43. A machine readable medium having instructions stored thereon for allowing select access to a secure location, the method comprising:
detecting change in reactance in a loop field;
initiating time tracking process;
imaging the body;
comparing an image of the body with a stored image associated with information received from an RFID tag activated by the loop field; and
indicating a match when the image of the body and the stored image match.

44. The method of claim 43, further comprising:
activating the RFID tag; and
in response to the activation, transmitting body data.

45. The method of claim 43, wherein comparing an image of the body with a stored image further comprises:
performing a biometric verification.

46. The method of claim 43, further comprising:
synchronizing the timing of events.

47. The method of claim 43, further comprising:
verifying RFID tag information.
